(19) United States
(12) Patent Application Publication
(10) Pub. No.: US 2018/0244960 A1
(43) Pub. Date: Aug. 30, 2018

(54) Use of Cellulose Ethers Having 3-Azido-Hydroxyalkyl Groups in Insoluble Adhesives

(71) Applicant: SE Tylose GmbH & Co. KG, Wiesbaden (DE)

(72) Inventor: Mike KLEINERT, Wiesbaden (DE)

(73) Assignee: SE Tylose GmbH & Co. KG

(21) Appl. No.: 15/758,503

(22) PCT Filed: Sep. 13, 2016
(86) PCT No.: PCT/EP2016/071569

§ 371 Date: Mar. 8, 2018

(30) Foreign Application Priority Data
Sep. 18, 2015 (DE) 10 2015 115 804.3

(51) Int. Cl. C09J 101/28; B32B 37/12

(52) U.S. Cl. CPC C09J 101/288; B32B 2317/16; B32B 37/1284

(57) ABSTRACT

The invention relates to the use of non-ionic, insoluble cellulose ethers having 3-azido-2-hydroxypropyl (AHP) groups, which are linked to the cellulose via an ether link, wherein the molar substitution degree MSAHP is in the region of 0.001 to 0.30, for the production of insoluble, solid adhesives. The cellulose ethers substituted by AHP groups are reacted in the presence of a copper or ruthenium catalyst with alkine compounds, such as phenylacetylene, propargyl alcohol, propiolic acid or heterocyclic compounds, which have a substituent with a terminal alkine group. The reaction of the azide with the alkine occurs as a 1,3-dipolar cyclcoaddition reaction at room temperature within a few seconds, and an insoluble, solid adhesive is obtained. The adhesive is suitable in particular for adhering paper, cardboard or wood.

The invention relates to the use of cellulose ethers with 3-azido-hydroxyalkyl groups in water-insoluble adhesives. The cellulose ethers are, in particular, nonionic mixed ethers, based on hydroxyalkylcelluloses, such as hydroxyethylcellulose (HEC) or hydroxypropylcellulose (HPC), with a coetherification by azidohydroxyalkyl substituents. The adhesives are, in particular, suitable for adhesively bonding paper, paperboard, wood or other materials which are based on cellulose or comprise cellulose.

Nonionic cellulose ethers which comprise 3-azido-2-hydroxyalkyl groups, especially 3-azido-2-hydroxypropyl groups (AHP groups), and also processes for preparing them, are already disclosed in EP 2 712 873 A1. The cellulose ethers thus modified are water-soluble. Through the incorporation of the stated groups it is possible to modify the rheological properties of the cellulose ethers within wide ranges, by reacting the azide termini with alkynes.

Cellulose ethers have possible uses including, as is known, their use as adhesives (e.g., wallpaper pastes). Under the action of water or moisture, however, the adhesive effect declines severely, because the cellulose ethers are dissolved to a greater or lesser extent.

For instance, U.S. 2015/0232724 A1 discloses a wood glue whose essential constituents are Na carboxymethylcellulose and a polymeric quaternary amine, a reaction product, for example, of a polyamidoamine and epichlorohydrin.

The object was therefore to provide cellulose ethers with which it is possible to produce adhesive bonds which do not lose bond strength even in a moist environment.

It has now been found that water-soluble cellulose ethers with 3-azido-2-hydroxyproyl groups produce moisture-stable adhesive bonds if they are mixed with alkynes and with copper catalysts and/or ruthenium catalysts. In this case the azide groups react with the alkyne groups in a cycloaddition reaction to give [1,2,3]-triazole groups. The result is a solid adhesive which retains its properties even in a moist environment.

A subject of the invention, accordingly, is the use of nonionic, water-soluble cellulose ethers with 3-azido-2-hydroxypropyl groups, joined to the cellulose or to the cellulose ether via an ether bond, the degree of molar substitution MS_{AHP} being in the range from 0.001 to 0.30, for producing water-insoluble, solid adhesives. As well as the 3-azido-2-hydroxypropyl groups and the hydroxyalkyl groups, the cellulose ethers may also have alkyl groups, especially straight-chain or branched C₁-C₆ alkyl groups, such as methyl, ethyl, propyl, isopropyl, butyl or isobutyl groups. The hydroxyalkyl groups preferably have 2 to 6 carbon atoms, and in particular they are 2-hydroxyethyl or 2-hydroxypropyl groups.

Water-insoluble, solid adhesive bonds are obtained if the water-soluble cellulose ethers with AHP groups are mixed with alkynes or dialkynes and the AHP groups are reacted with the alkyne groups, catalyzed by copper compounds and/or ruthenium compounds.

Preferred starting materials, accordingly, are water-soluble, nonionic cellulose ethers, such as hydroxyethylcellulose (HEC), methylhydroxyethylcellulose (MHEC), hydroxypropylcellulose (HPC) or methylhydroxypropylcellulose (MHPC). In the case of methylhydroxyethylcelluloses and methylhydroxypropylcelluloses, the DS (Me) is generally 1.0 to 2.5, preferably 1.2. to 2.5, more preferably 1.4 to 1.9, and the MS (HE and/or HP) is generally 0.01 to 1.0, preferably 0.05 to 0.8, more preferably 0.05 to 0.6. In the case of hydroxyethylcelluloses and hydroxypropylcelluloses, the MS (HE and/or HP) is generally 1.0 to 4.0, preferably 1.5 to 3.3.

“Water-soluble” in connection with the present invention means that the unmodified cellulose ether is soluble in cold water (20° C.) to an extent of more than 1.0% (w/w), preferably more than 10% (w/w), more preferably more than 20% (w/w).

The cellulose ethers with AHP groups are obtainable by reacting the corresponding cellulose ether with glycidyl azide. The 3-azido-2-hydroxypropyl groups here may be bonded via the hydroxyl groups of the ethylene glycol and/or propylene glycol side chains, or via the hydroxyl groups on the pyranose ring. The average degree of substitution of the cellulose by the 3-azido-2-hydroxypropyl groups (MS_{AHP}) is generally in the range from 0.001 to 0.30 per anhydroglucose unit, the MS being preferably in the range from 0.05 to 0.25. The cellulose ethers substituted by azido groups usefully have an average degree of polymerization DPₙ of 50 to 4000, preferably of 100 to 2500, more preferably of 250 to 1500.

Cellulose ethers with 3-azido-2-hydroxypropyl groups can also be obtained if alkalified cellulose is reacted, immediately in succession or simultaneously, with an alkylene oxide and glycidyl azide in one and the same reactor in the form of a conventional co-etherification.

The thermally induced Huisgen cycloaddition produces mixtures of regioisomers. The 1,3-dipolar cycloaddition of azides onto alkynes (Huisgen reaction) therefore takes place usefully by means of Cu(I) catalysts. In this case, regioselectively, 1,4-disubstituted [1,2,3]-triazoles are produced. Suitability is possessed for example by Cu(I) bromide, Cu(I) iodide or Cu(I) acetate. Catalytically active Cu(I) salts can also be prepared in situ, as for example from copper(II) sulfate by reduction with ascorbic acid in aqueous solution. The metal-catalyzed reactions generally proceed even at room temperature. The conversion of the liquid or fluid starting materials into a solid adhesive takes place even at room temperature within a few seconds, generally in less than 60 seconds, preferably in less than 10 seconds.

The azide-alkyne cycloaddition may also be catalyzed by ruthenium compounds, as for example by bis-(triphenylphosphine)cyclopentadienylruthenium chloride. In that case, however, in contrast to the copper-catalyzed reaction, 1,5-disubstituted [1,2,3]-triazoles are obtained regioselectively.

Particularly suitable alkynes are phenylacetylene, propargyl alcohol, propiolic acid, and other compounds having a terminal C-C triple bond. It is also possible for compounds having 2 carbon-carbon triple bonds (diynes) to be used.

Of general suitability as alkyne building blocks in the Huisgen reaction are:
a) alkynes of the formula H—C≡C—R⁴,
   where R⁴ is
   a straight-chain or branched )C₁-C₁₈) alkyl radical,
   an alkeyl radical of the formula —[CH₂]ₘ—CH≡CH₂, where m is an integer from 1 to 8,
   a substituted alkyl radical of the formula —[CH₂]ₙ—CX₂Y,
   where n is an integer from 0 to 8, X is hydrogen, fluorine or chlorine, and Y is hydrogen, fluorine, chlorine, NH₂, OH, )—CH₃, CO₂H or CO₂CH₃, with the proviso that X and Y are not both a hydrogen atom,
   a polyoxyalkylene radical of the formula —[CH₂—CH₂—O]ₚ—CH₂Z,
   where p is an integer from 1 to 8 and Z is a hydrogen atom or a methyl group,
   an aromatic radical, preferably a phenyl group, biphenyl or naphthyl group,
   a substituted aromatic radical, the substituents bonded to aromatic carbon atoms being identical or different and selected from the group consisting of H, F, Cl, NH₂, CH₃ or OCH₃, with the proviso that not all the substituents are a hydrogen atom; or
   is a heterocyclic radical, such as 1H-imidazole-1-carbonyloxymethyl;
or
b) is diynes of the formula H—C≡C—R⁵—C≡C—H,
   where R⁵ is
   a divalent aromatic radical, such as ortho-, meta- or para-phenylene, biphenyl-4,4′-diyl or naphthalene-1, 4-diyl, or
   a substituted divalent aromatic radical, the substituents bonded to aromatic carbon atoms being identical or different and selected from the group consisting of H, F, Cl, NH₂, CH₃ or OCH₃, it also being possible for different substituents to be combined, with the proviso that not all the substituents are a hydrogen atom.

The cycloaddition reaction can be carried out with a large number of different alkynes. Accordingly, solid adhesives with the various properties are accessible in a simple way. This makes the reaction significantly more flexible than a conventional grafting reaction. It can be carried out in the presence of water, organic solvents, or mixtures of water with organic solvents. Suitable organic solvents are, for example, tetrahydrofuran, dioxane, dimethyl sulfoxide, acetontrile, methylene chloride, chloroform, methanol, ethanol, tert-butanol, ethyl acetate, acetone or dimethylformamide.

AHP-HEC is highly soluble in water and forms a clear, viscous solution in water. Surprisingly it has been found that the rheological properties of the dissolved AHP-HECs can be reversed completely after the reaction with alkyne building blocks, as for example with phenylacetylene. From viscous fluids, in the manner described, solids with a structurally elastic behavior are obtained.

There may be further radicals bonded covalently to the alkyne component. Accordingly, the products from the cycloaddition reaction may ne ionic or nonionic. The further radicals may also include reactive dyes, chromophores, crosslinking building blocks, or other radicals which give the adhesives particular properties.

The 1,3-dipolar cycloaddition reaction takes place in general within seconds with minimal amounts of catalyst. The catalyst need not be mixed directly with the AHP-cellulose ether and the alkynes. To effect the 1,3-dipolar cycloaddition it is sufficient if one of the workpieces to be bonded contains or is impregnated with a copper compound or ruthenium compound and enters into contact with the mixture of AHP-cellulose ether and alkyne. In alternative embodiments, the catalyst is premixed either with the AHP-cellulose ether or with the alkyne.

The examples which follow serve to illustrate the invention. Percentages therein are percentages by weight unless otherwise specified or unless immediately evident from the context. DS and MS values were determined by the Zeisel method.

### EXAMPLE 1

### Copper-Catalyzed Coupling of Azidohydroxypropyl-Hydroxyethylcellulose (AHP-HEC) with Phenylacetylene and Cu Catalysis for the Bonding of Wood

10.0 g of AHP-HEC (5% water content, MS(HE)=1.1, MS(GA)=0.15) were stirred into 1000 ml of cold drinking water and dissolved at room temperature by stirring. The clear solution had a viscosity of about 250 mPa s (Brookfield, LV). Added thereto with stirring were 2.0 g of phenylacetylene, causing no measurable change to the viscosity. A portion (approximately 50 ml) of this low-mobility, slightly turbid mixture was then applied by brush to two smooth, dry spruce-wood surfaces. After waiting for around 5 minutes for partial retreat of the solution into the pores in the wood, one of the two wood surfaces was sprayed, using a commercial spray bottle, with a solution consisting of 10.0 g of copper sulfate pentahydrate and 18.0 g of ascorbic acid in 60 ml of degassed, demineralized water, and immediately the other wood surface, likewise coated with glue, was pressed on by gentle rubbing movements and fixed, as is also carried out in the art in the conventional gluing of wood.

The next day, the bond had dried and the wooden pieces could not be moved relative to one another or removed from one another. Immersion of the bonded wooden plates in water over a period of 1.8 hours did not noticeably affect the bonding, and, while it was possible to break the bond with considerable application of force, fibers were torn from the other workpiece in each case.

### EXAMPLE 2

### Bonding of Wood as Described above but Without Catalyst Influence

The procedure described above in example 1 was followed completely analogously except for the spraying of the aqueous catalyst solution. The two wooden workpieces were similarly assembled and fixed overnight while pressed together. Here again, after a dry storage period of around 18 hours, the bond formed between the two pieces of wood could be parted again with a certain application of manual force, but without fibers being torn out.

A repeat experiment in which, instead of the application of force to part the bond, the bonded workpiece was first immersed in water for around 6 hours showed complete dissolution of the “glued bond”.

### EXAMPLE 3

### Copper-Catalyzed Coupling of Azidohydroxypropylhydroxyethylcellulose (AHP-HEC) with 1,4-diethynylbenzene and Cu Catalysis for the Bonding of Wood

1.0 g of AHP-HEC (5% WC, MS(HE)=1.1, MS(GA)=0.15) were stirred into 1000 ml of cold drinking water and dissolved at room temperature by stirring. The clear solution had a viscosity of about 250 mPa s (Brookfield, LV). Added thereto with stirring were 2.0 g of diethynylbenzene [935-14-8], causing no measurable change to the viscosity. A portion (approximately 50 ml) of this low-mobility, slightly turbid mixture was then applied by brush to two smooth, dry spruce-wood surfaces. After waiting for around 5 minutes for partial retreat of the solution in the pores in the wood, one of the two wood surfaces was sprayed, using a commercial spray bottle, with a solution consisting of 10.0 g of copper sulfate pentahydrate and 18.0 g of ascorbic acid in 50 ml of degassed, demineralized water, and immediately the other wood surface, likewise coated with glue, was pressed on by gentle rubbing movements and fixed, as is also carried out in the art in the conventional gluing of wood.

The next day, the bond had dried and the wooden pieces could not be moved relative to one another or removed from one another. Immersion of the bonded wooden plates in water over a period of 18 hours did not noticeably affect the bonding, and, while it was possible to break the bond with considerable application of force, fibers were torn from the other workplace in each case.

1. Water-insoluble, solid adhesives for adhesively bonding paper, paperboard, wood or other materials based on cellulose or comprising cellulose, said adhesives comprising, nonionic, water-soluble cellulose ethers with 3-azido-2-hydroxypropyl groups, joined to the cellulose via an ether bond, the cellulose having a degree of molar substitution MS_{AHP} being in the range from 0.001 to 0.30, the cellulose ethers being reacted with an alkyne, and catalyzed by a copper compound and/or ruthenium compound.

2. The adhesives as claimed in claim 1, wherein the cellulose ethers have alkyl and/or hydroxyalkyl groups as well as 3-azido-2-hydroxypronyl groups.

3. The adhesives as claimed in claim 2, wherein the alkyl groups are straight-chain (C1-C6)alkyl groups preferably methyl or ethyl groups.

4. The adhesives as claimed in claim 2, wherein the hydroxyalkyl groups are 2-hydroxyethyl or 2-hydroxypropyl groups.

5. The adhesives as claimed in claim 1, wherein the MS_{AHP} is in the range from 0.05 to 0.25.

6. The adhesives as claimed in claim 2, wherein in the case of alkylhydroxyalkylcelluloses with 3-azido-2-hydroxypropyl groups, the DS(alkyl) is in the range from 1.0 to 2.5, and the MS (HE and/or HP) is in the range from 0.01 to 1.0.

7. The adhesives as claimed in claim 2, wherein in the case of hydroxyalkylcelluloses with 3-azido-2-hydroxypropyl groups, the MS(hydroxyalkyl) is in the range from 1.0 to 4.0.

8. The adhesives as claimed in claim 1, wherein the cellulose ether substituted by AHP groups has an average degree of polymerization DPn of 50 to 4000.

9. The adhesives as claimed in claim 8, wherein the alkyne
a) is a compound of the formula H—C≡C—R⁴,
where R⁴ is
a straight-chain or branched (C₁-C₁₈)alkyl radical,
an alkenyl radical of the formula —[CH₂]m—CH═CH₂, where m is an integer from 1 to 8,
a substituted alkyl radical of the formula —[CH₂]ₙ—CX₂Y,
where n is an integer from 0 to 8, X is hydrogen, fluorine or chlorine, and Y is hydrogen, fluorine, chlorine, NH₂, OH, O—CH₃, CO₂H or CO₂CH₃, with the proviso that X and Y are not both a hydrogen atom,
a polyoxyalkylene radical of the formula —[CH₂—CH₂—O]ₚ—CH₂Z,
where p is an integer from 1 to 8 and Z is a hydrogen atom or a methyl group,
an aromatic radical,
a substituted aromatic radical, the substituents bonded to aromatic carbon atoms being identical or different and selected from the group consisting of —H, —F, —Cl, —NH₂, —CH₃ or —OCH₃, with the proviso that not all the substituents are a hydrogen atom; or
is a heterocyclic radical;
or
b) is a diyne of the formula H—C≡C—R⁵—C≡C—H,
where R⁵ is
a divalent aromatic radical or
a substituted divalent aromatic radical, the substituents bonded to aromatic carbon atoms being identical or different and selected from the group consisting of H, F, Cl, NH₂, CH₃ or OCH₃, with the proviso that not all the substituents are a hydrogen atom.

10. The adhesives as claimed in claim 8, wherein the alkyne is phenylacetylene, propargyl alcohol, propiolic acid or propargyl 1H-imidazole-1-carboxylate.

11. The adhesives as claimed in claim 3, wherein the alkyl groups are methyl or ethyl groups.

12. The adhesives as claimed in claim 6, wherein the DS(alkyl) is in the range from 1.2 to 2.1, and the MS (HE and/or HP) is in the range from 0.05 to 0.8.

13. The adhesives as claimed in claim 6, wherein the DS(alkyl) is in the range from 1.4 to 1.9, and the MS (HE and/or HP) is in the range 0.05 to 0.6.

14. The adhesives as claimed in claim 7, wherein the MS(hydroxyalkyl) is in the range from 1.5 to 3.5.

15. The adhesives as claimed in claim 8, wherein the cellulose ether substituted by AHP groups has an average degree of polymerization DPₙ of 100 to 2000.

16. The adhesives as claimed in claim 8, wherein the cellulose ether substituted by AHP groups has an average degree of polymerization DPₙ of 600 to 1400.

17. The adhesives as claimed in claim 9, wherein the aromatic radical is a phenyl group, biphenyl or naphthyl group, and the divalent aromatic radical is ortho-, meta- or para-phenylene biphenyl-4,4′-diyl or naphthalene-1,4-diyl.
